(19) United States
(12) Patent Application Publication
(10) Pub. No.: US 2024/0301749 A1
(43) Pub. Date: Sep. 12, 2024

(54) WINDOW BLIND AND CLAMPING MEMBER THEREOF

(71) Applicant: Ya-Yin LIN, Chiayi City (TW)

(72) Inventor: Ya-Yin LIN, Chiayi City (TW)

(21) Appl. No.: 18/363,923

(22) Filed: Aug. 2, 2023

(30) Foreign Application Priority Data
Mar. 8, 2023 (TW) 112202006

(51) Int. Cl. E06B 9/38; E06B 9/30

(52) U.S. Cl. CPC E06B 9/38; E06B 9/30

(57) ABSTRACT

A clamping member is adapted for being mounted on a blind unit that extends along a longitudinal direction, and for a pull cord to pass therethrough. The blind unit includes a plurality of blind holes spaced apart from one another along the longitudinal direction and extending through the blind unit. The clamping member includes a plug block that is configured for being mounted in one of the blind holes and that defines a through hole for the pull cord to pass therethrough, and at least one clamping slot that communicates with the through hole, that extends along a transverse direction which is perpendicular to the longitudinal direction, and that is configured for clamping the pull cord to limit movement of the pull cord. The clamping slot has a communicating end proximate to and communicating with the through hole, and a clamping end distal from the through hole and closed.

### CROSS-REFERENCE TO RELATED APPLICATION

This application claims priority to Taiwanese Utility Model patent application Ser. No. 11/220,2006, filed on Mar. 8, 2023.

### FIELD

The disclosure relates to a window blind and a clamping member thereof.

### BACKGROUND

Referring to FIG. 1, a conventional window blind includes a top seat 91 mounted above a window, a bottom seat 92 parallel to the top seat 91 and located below the top seat 91 for providing a stable weight, a plurality of blind units 93 parallel to one another and vertically spaced apart from one another between the top seat 91 and the bottom seat 92, two pull cords 94 horizontally spaced apart from each other, and two ladder strings 95 disposed at two ends of the blind units 93. The top seat 91 includes a pull cord positioner 911 and an angle adjuster 912. Each of the blind units 93 includes two blind holes 931. Each of the pull cords 94 has one portion fixed to the bottom seat 92, and another portion extending vertically through one of the two blind holes 931 of each of the blind units 93. The ladder strings 95 are controlled by the angle adjuster 912 to adjust angles of the blind units 93.

The another portion of each of the pull cords 94 further passes through the pull cord positioner 911 and has an operable part that is located outside the window blind. When the operable part of the pull cord 94 is pulled down, a part of the pull cord 94 that is located inside the window blind is shorten and the blind units 93 are raised. When the operable part of the pull cord 94 is pulled toward an outward direction that is parallel to a longitudinal direction (X) of the blind units 93, the pull cord positioner 911 is driven to clamp the pull cord 94 such that the blind units 93 are fixed at a raised position. Then, when the operable part of the pull cord 94 is pulled toward an inward direction opposite to the outward direction and is released, the pull cord positioner 911 is driven to unclamp the pull cord 94 and the blind units 93 are released.

Since the pull cord positioner 911 is only disposed on the top seat 91, the part of the pull cord 94 that is located inside the window blind may be pulled out. The pull cord 94 between two adjacent ones of the blind units 93 may be pulled by a child playing near the window blind, resulting in the pulled-out part of the pull cord 94 forming a circle with the blind units 93, thereby leading to possible strangling of the child and causing suffocation. Therefore, the conventional window blind is not safe enough and needs to be improved.

### SUMMARY

Therefore, an object of the disclosure is to provide a clamping member thereof that can alleviate at least one of the drawbacks of the prior art.

According to the disclosure, the clamping member is adapted for being mounted on a blind unit that extends along a longitudinal direction, and for a pull cord to pass therethrough. The blind unit includes a first surface and a second surface that are spaced apart from and opposite to each other, and a plurality of blind holes that are spaced apart from one another along the longitudinal direction and that extend through the first surface and the second surface.

The clamping member includes a plug block that is configured for being mounted in one of the blind holes and that defines a through hole for the pull cord to pass therethrough, and at least one clamping slot communicating with the through hole, extending along a transverse direction which is perpendicular to the longitudinal direction, and configured for clamping the pull cord to limit movement of the pull cord when the pull cord is moved along the transverse direction. The at least one clamping slot has a communicating end that is proximate to and that communicates with the through hole, and a clamping end that is distal from the through hole and that is closed.

Another object of the disclosure is to provide a window blind that can alleviate at least one of the drawbacks of the prior art.

According to the disclosure, the window blind includes a plurality of blind units that are parallel to one another and that are spaced apart from one another, a plurality of pull cords, and a plurality of clamping members.

Each of the blind units extends along a longitudinal direction and includes a first surface, a second surface that is spaced apart from and opposite to the first surface, and a plurality of blind holes that are spaced apart from one another along the longitudinal direction and that extend through the first surface and the second surface.

The pull cords are spaced apart from one another along the longitudinal direction, extend through the blind holes of the blind units in an up-down direction, and are operable to raise or lower the blind units.

Each of the clamping members includes a plug block that is mounted in one of the blind holes of the blind units. The plug block defines a through hole through which a corresponding one of the pull cords passes in the up-down direction, and at least one clamping slot which communicates with the through hole, which extends along a transverse direction perpendicular to the longitudinal direction and which is configured for clamping the corresponding one of the pull cords to limit movement of the corresponding one of the pull cords when the corresponding one of the pull cords is moved along the transverse direction. The at least one clamping slot has a communicating end that is proximate to and that communicates with the through hole, and a clamping end that is distal from the through hole and that is closed.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view of a conventional window blind.

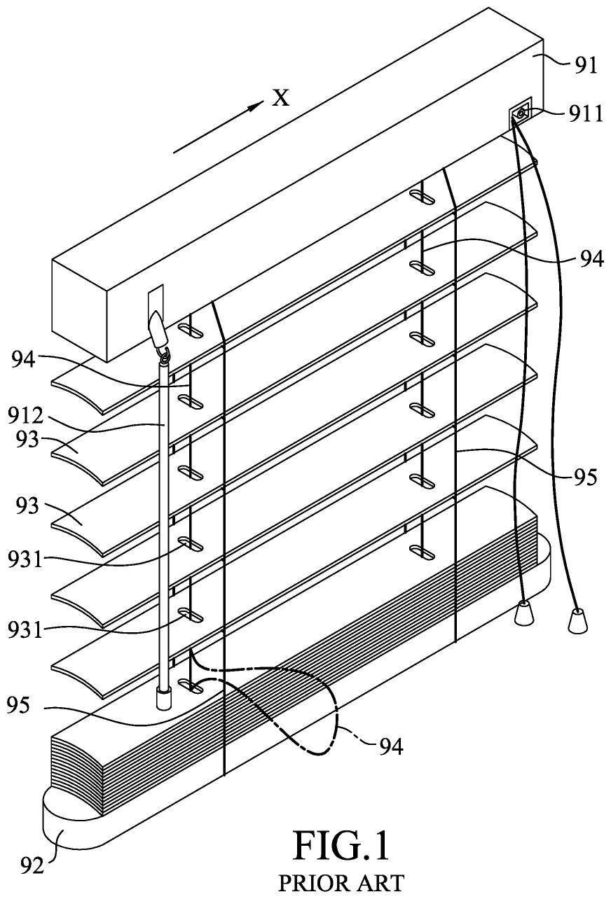

FIG. 2 is a perspective view of a window blind according to a first embodiment of the disclosure.

FIG. 3 is a fragmentary exploded view of the first embodiment.

FIG. 4 is a fragmentary top view of the first embodiment.

FIG. 5 is a sectional view taken along line V-V in FIG. 4, illustrating a clamping member that is mounted on a blind hole.

FIG. 6 is a top view similar to FIG. 4, illustrating a pull cord that is clamped by the clamping member.

FIG. 7 is a fragmentary exploded view of the window blind according to a second embodiment of the disclosure.

FIG. 8 is a sectional view of the second embodiment, illustrating the clamping member that is mounted on the blind hole.

FIG. 9 is a perspective view of the clamping member of the window blind according to a third embodiment of the disclosure.

FIG. 10 is a fragmentary top view of the third embodiment.

FIG. 11 is a perspective view of the clamping member of the window blind according to a fourth embodiment of the disclosure.

FIG. 12 is a sectional view of the fourth embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,”“bottom,”“upper,”“lower,”“on,”“above,”“over,”“downwardly,”“upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

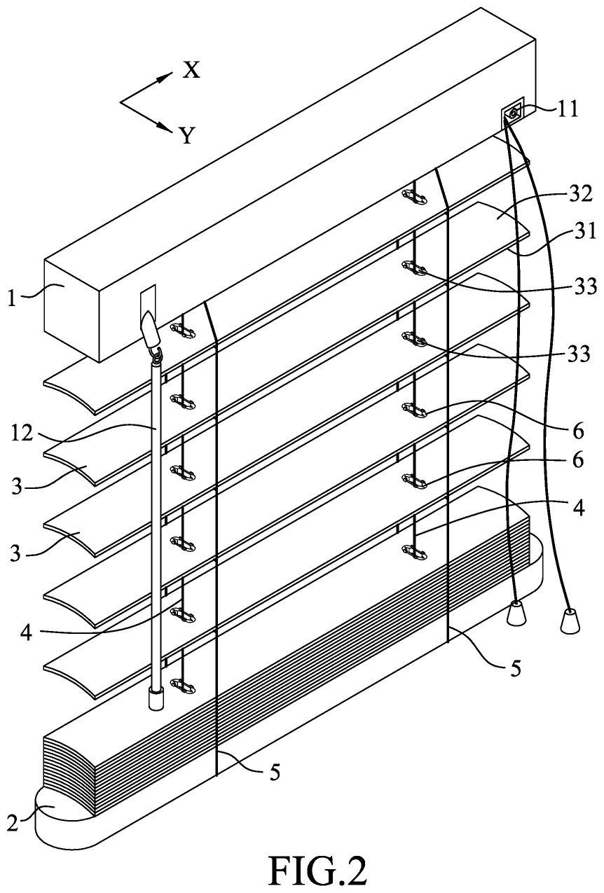

Referring to FIGS. 2, 3, and 4, a window blind according to a first embodiment of the disclosure includes a top seat 1, a bottom seat 2, a plurality of blind units 3, two pull cords 4, two ladder strings 5, and a plurality of clamping members 6.

The top seat 1 is adapted to be mounted on a window (not shown), and includes a pull cord positioner 11 for clamping the pull cords 4 and an angle adjuster 12 for adjusting angles of the blind units 3.

The bottom seat 2 is located below and parallel to the top seat 1, and is used for providing a stable weight.

The blind units 3 are parallel to one another, are spaced apart from one another in an up-down direction, and are disposed between the top seat 1 and the bottom seat 2. Each of the blind unit 3 extends along a longitudinal direction (X), and includes a first surface 31 and a second surface 32 spaced apart from and opposite to each other in the up-down direction, and two blind holes 33 spaced apart from each other along the longitudinal direction (X) and extending through the first surface 31 and the second surface 32. Each of the blind holes 33 extends in a transverse direction (Y) perpendicular to the longitudinal direction (X). The number of the blind holes 33 of each of the blind units 3 is not limited to two, and may be three, four, or more than four, depending on the length of the blind unit 3.

The pull cords 4 are spaced apart from each other in the longitudinal direction (X). Each of the pull cords 4 has one portion fixed to the bottom seat 2, and another portion extending vertically through one of the blind holes 33 of each of the blind units 3. The number of the pull cords 4 is not limited to two, and may be three, four, or more than four, depending on the number of the blind holes 33 of each of the blind units 3.

The ladder strings 5 are disposed at two ends of the blind units 3, and are controlled by the angle adjuster 12 to adjust the angles of the blind units 3.

The clamping members 6 are mounted on the blind units 3 for the pull cords 4 to pass therethrough. Specifically, the clamping members 6 are mounted on each of the blind units 3 in pair such that the clamping members 6 of each pair are spaced apart from each other in the longitudinal direction (X). The detailed structure of the clamping member 6 will be described below.

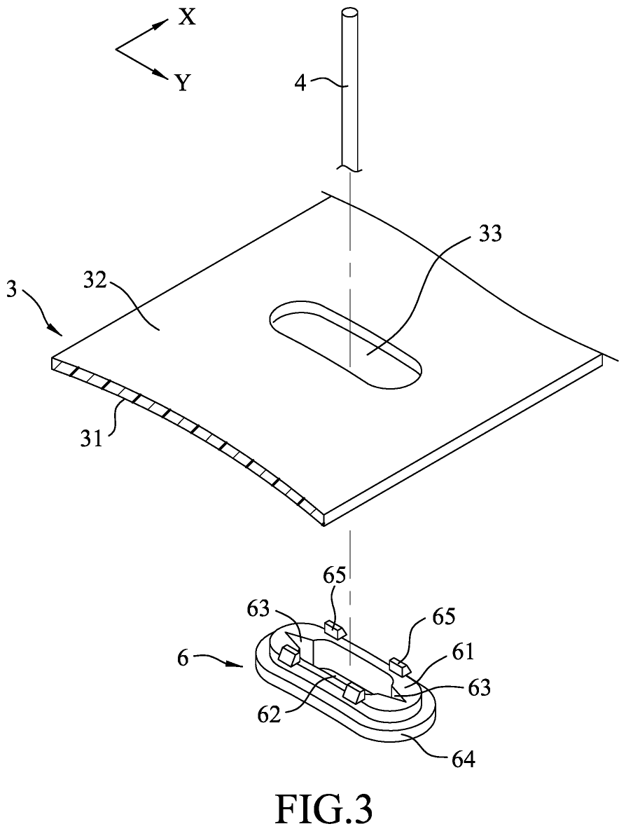

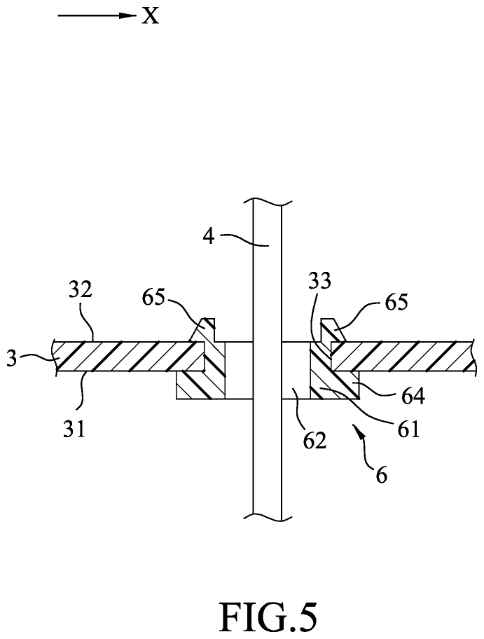

Referring to FIGS. 3, 4, and 5, each of the clamping members 6 is generally an elliptical ring, and includes a plug block 61, a flange 64 extending from an outer peripheral surface of the plug block 61 and configured for abutting against the first surface 31 of a corresponding one of the blind units 3 on which the clamping member 6 is mounted, and four engaging protrusions 65 protruding outwardly from a surface that is connected to the outer peripheral surface and configured for engaging the second surface 32 of the corresponding one of the blind units 3. The clamping members 6 may have other shapes depending on the shapes of the blind holes 33. In this embodiment, the first surface 31 is a lower surface, and the second surface 32 is an upper surface; however, the clamping members 6 may be mounted upside down, so that the first surface 31 may be the upper surface, and the second surface 32 may be the lower surface, correspondingly. The number of the engaging protrusions 65 is not limited to four, and may be more than four depending on the situation.

The plug block 61 of each of the clamping members 6 is configured for being mounted in one of the blind holes 33, and defines a through hole 62 extending along the transverse direction (Y) for the corresponding one of the pull cords 4 to pass vertically therethrough, and two clamping slots 63 respectively located at a front side and a rear side of the through hole 62 at the transverse direction (Y) and communicating with the through hole 62. Each of the clamping slots 63 extends along the transverse direction (Y), and is configured for clamping the corresponding one of the pull cords 4 to limit movement of the corresponding one of the pull cords 4 when the corresponding one of the pull cords 4 is moved along the transverse direction (Y). Each of the clamping slots 63 has a communicating end 631 that is proximate to and that communicates with the through hole 62, and a clamping end 632 that is distal from the through hole 62 and that is closed. The width (i.e., a dimension in the longitudinal direction (X)) of each of the clamping slots 63 gradually decreases from the communicating end 631 to the clamping end 632, and is reduced to zero at the clamping end 632.

Referring to FIG. 2, the another portion of each of the pull cords 4 further passes through the pull cord positioner 11, and has an operable part located outside the window blind and operable to raise or lower the blind units 3. When the operable part of the pull cord 4 is pulled down, a part of the pull cord 4 located inside the window blind is shorten and the blind units 3 are raised. When the operable part of the pull cord 4 is pulled toward an outward direction that is parallel to the longitudinal direction (X), the pull cord positioner 11 is driven to clamp the pull cord 4 such that the blind units 3 are fixed at a raised position. Then, when the operable part of the pull cord 4 is pulled toward an inward direction opposite to the outward direction and is released, the pull cord positioner 11 is driven to unclamp the pull cord 4 and the blind units 3 are released.

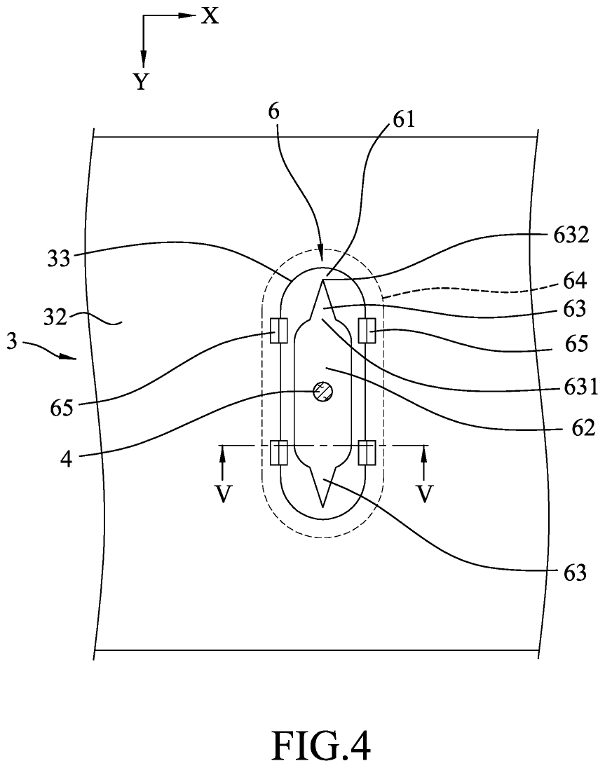

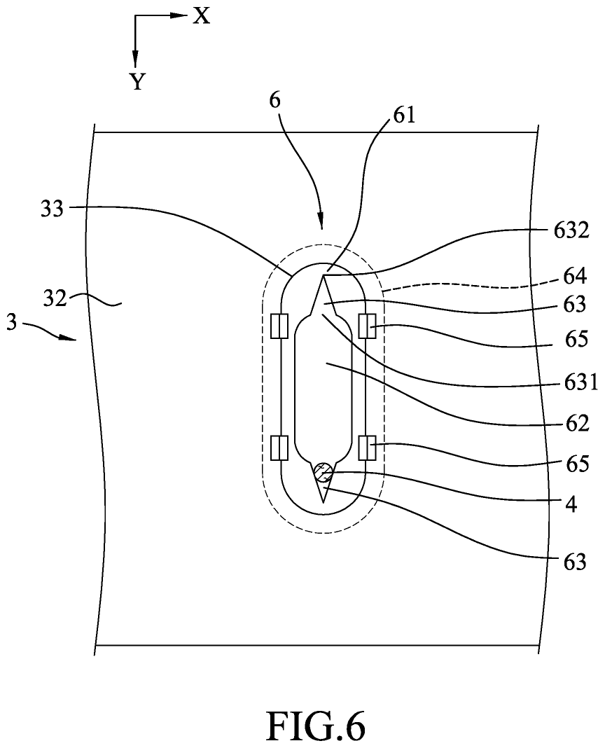

Referring to FIGS. 4 and 6, when a child plays near the window blind of the disclosure, the part of the pull cord 4 located inside the window blind may be pulled forward in the transverse direction (Y) by the child. At this time, since the width of the clamping slot 63 of the clamping member 6 gradually decreases from the communicating end 631 to the clamping end 632 and is reduced to zero at the clamping end 632, the pull cord 4 is clamped by the clamping slot 63 (see FIG. 6) so that the pull cord 4 and the blind units 3 may be prevented from forming a circle that may strangle the child's neck, thereby enhancing the safety of use.

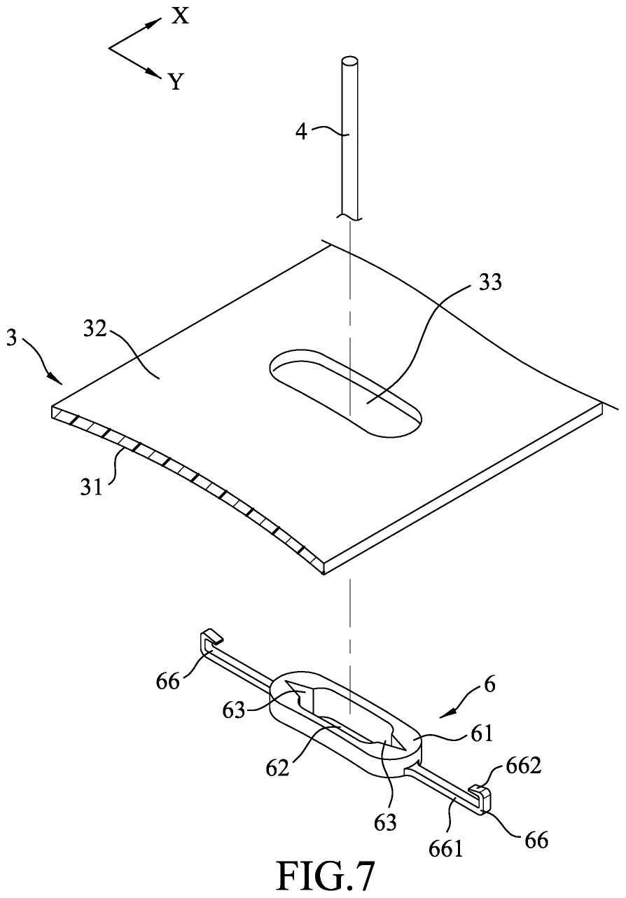

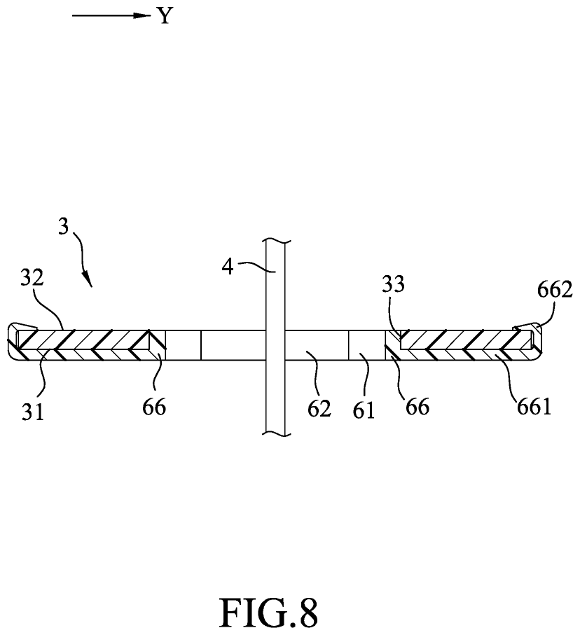

Referring to FIGS. 7 and 8, a window blind according to a second embodiment of the disclosure has a structure generally identical to the window blind of the first embodiment but differs in that each of the clamping members 6 includes the plug block 61, and two hooks 66 extending from the outer peripheral surface of the plug block 61 and configured for hooking the blind unit 3 corresponding thereto. Each of the hooks 66 includes an extension portion 661 that extends along the transverse direction (Y) and that is proximate to the first surface 31 of the blind unit 3 when the plug block 61 is mounted in the blind hole 33, and an engaging portion 662 that extends from the extension portion 661 and that is configured for engaging the second surface 32 of the blind unit 3.

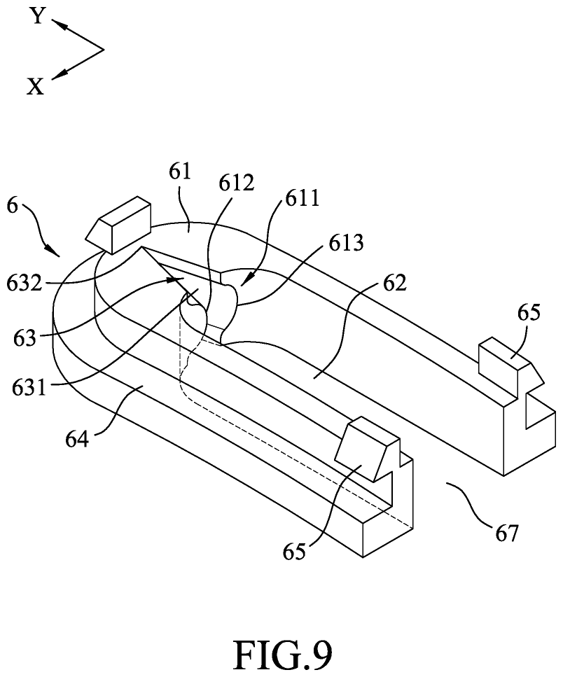

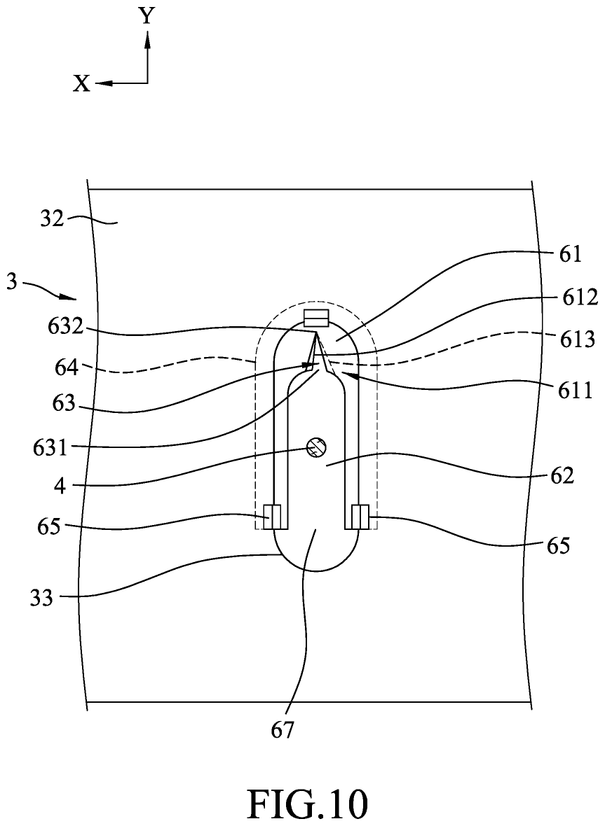

Referring to FIGS. 9 and 10, a window blind according to a third embodiment of the disclosure has a structure generally identical to the window blind of the first embodiment but differs in that the plug block 61 of each of the clamping slot 6 defines one clamping slot 63, and the clamping slot 63 is located at the front side of the through hole 62 in the transverse direction (Y). The plug block 61 of the clamping members 6 includes a wave portion 611 that corresponds to the clamping slot 63, and that has a convex surface 612 and a concave surface 613 corresponding to each other and cooperatively defining the clamping slot 63. The convex surface 612 and the concave surface 613 converge toward the transverse direction (Y), and are convex or concave substantially along the longitudinal direction (X), so that the clamping slot 63 is bent and firmly clamps the corresponding one of the pull cords 4 more. The plug block 61 and the flange 64 cooperatively define an opening 67 that communicates with the through hole 62 and that is located at the rear side of the through hole 62 in the transverse direction (Y), so that the clamping member 6 is U-shaped. Each of the clamping members 6 includes three engaging protrusions 65, two of which are located at two ends of the clamping member 6, and one of which is located at a middle portion of the clamping member 6. The number of the engaging protrusions 65 is not limited to three, and may be more than three, depending on the actual situation. The application of the wave portion 611 is not limited to the third embodiment, and is also applicable to the first embodiment and the second embodiment. In such examples where the wave portion 611 is applied to the first embodiment or the second embodiment, the number of the wave portion 611 is two.

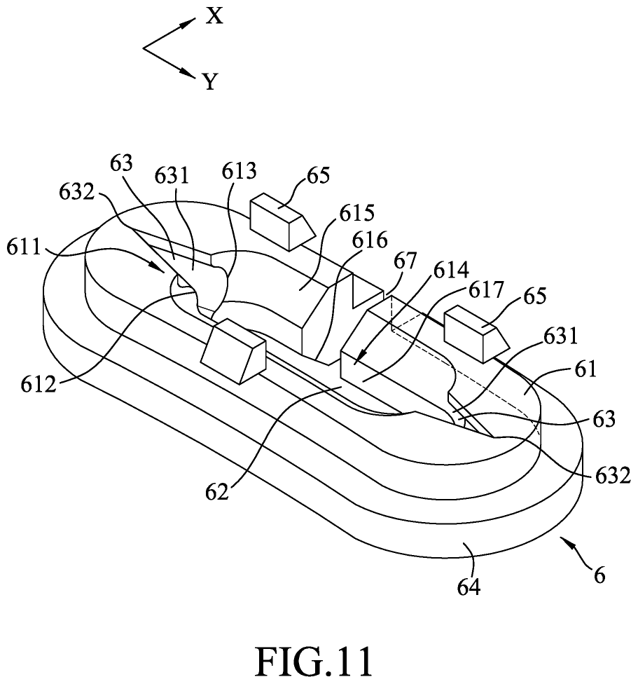

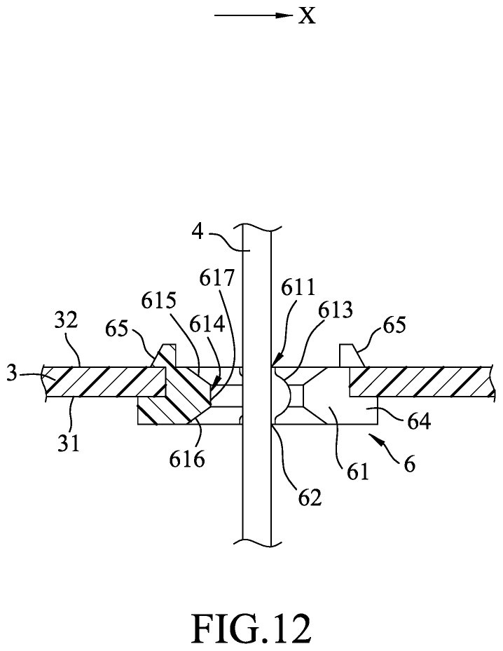

Referring to FIGS. 11 and 12, a window blind according to a fourth embodiment of the disclosure has a structure generally identical to the window blind of the first embodiment but differs in that the plug block 61 further includes an inner wall surface 614 defining the through hole 62. The inner wall surface 614 has an upper inclined portion 615, a lower inclined portion 616, and a vertical portion 617 interconnecting the upper inclined portion 615 and the lower inclined portion 616. The upper inclined portion 615 is inclined downward from a top surface of the plug block 61. The lower inclined portion 616 is inclined upward from a bottom surface of the plug block 61. The upper inclined portion 615, the lower inclined portion 616, and the vertical portion 617 cooperatively define the through hole 62, so that when the blind units 3 are tilted, the pull cord 4 may still pass vertically through the through hole 62. The plug block 61 and the flange 64 cooperatively define the opening 67 communicating with the through hole 62 along the longitudinal direction (X).

In summary, by virtue of the plug block 61 and the through hole 62 of each of the clamping members 6, the clamping members 6 may be mounted on the blind holes 33 of the blind units 3. Furthermore, by virtue of the at least one clamping slot 63, each of the pull cords 4 is clamped when moving along the transverse direction (Y), so as to be prevented from forming a circle with the blind units 3. Therefore, the object of the disclosure may be achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,”“an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A clamping member adapted for being mounted on a blind unit that extends along a longitudinal direction, and for a pull cord to pass therethrough, the blind unit including a first surface and a second surface that are spaced apart from and opposite to each other, and a plurality of blind holes that are spaced apart from one another along the longitudinal direction and that extend through the first surface and the second surface, said clamping member comprising:
a plug block that is configured for being mounted in one of the blind holes and that defines a through hole for the pull cord to pass therethrough, and at least one clamping slot communicating with said through hole, extending along a transverse direction which is perpendicular to the longitudinal direction, and configured for clamping the pull cord to limit movement of the pull cord when the pull cord is moved along the transverse direction, said at least one clamping slot having a communicating end that is proximate to and that communicates with said through hole, and a clamping end that is distal from said through hole and that is closed.

2. The clamping member as claimed in claim 1, wherein a width of said at least one clamping slot gradually decreases from said communicating end to said clamping end, and is reduced to zero at said clamping end.

3. The clamping member as claimed in claim 1, wherein said plug block includes at least one wave portion that corresponds to said at least one clamping slot and that each has a convex surface and a concave surface corresponding to each other, cooperatively defining a corresponding one of said at least one clamping slot, and converging toward the transverse direction.

4. The clamping member as claimed in claim 3, wherein said at least one clamping slot includes two clamping slots, said two clamping slots being located at two sides of said through hole.

5. The clamping member as claimed in claim 1, wherein said at least one clamping slot includes two clamping slots, said two clamping slots being located at two sides of said through hole.

6. The clamping member as claimed in claim 5, further comprising two hooks that extend from an outer peripheral surface of said plug block and that are configured for hooking the blind unit, each of said two hooks including an extension portion that extends along the transverse direction, and an engaging portion that extends from said extension portion and that is configured for engaging the second surface of the blind unit.

7. The clamping member as claimed in claim 1, further comprising a flange that extends from an outer peripheral surface of said plug block and that is configured for abutting against the first surface of the blind unit, and a plurality of engaging protrusions that protrude outwardly from a surface connected to said outer peripheral surface and that are configured for engaging the second surface of the blind unit.

8. The clamping member as claimed in claim 7, wherein said at least one clamping slot includes one clamping slot, said plug block and said flange cooperatively defining an opening that communicates with said through hole, said one clamping slot being located at one side of said through hole that is in the transverse direction, said opening being located at another side of said through hole that is opposite to said one clamping slot.

9. The clamping member as claimed in claim 7, wherein said plug block and said flange cooperatively define an opening that communicates with said through hole along the longitudinal direction.

10. The clamping member as claimed in claim 1, wherein said plug block further includes an inner wall surface defining said through hole, said inner wall surface having an upper inclined portion that is inclined downward from a top surface of said plug block, a lower inclined portion that is inclined upward from a bottom surface of said plug block, and a vertical portion that interconnects said upper inclined portion and said lower inclined portion, said upper inclined portion, said lower inclined portion and said vertical portion cooperatively defining said through hole.

11. A window blind comprising:
a plurality of blind units that are parallel to one another and that are spaced apart from one another, each of said blind units extending along a longitudinal direction and including
a first surface,
a second surface that is spaced apart from and opposite to said first surface, and
a plurality of blind holes that are spaced apart from one another along the longitudinal direction and that extend through said first surface and said second surface;
a plurality of pull cords that are spaced apart from one another along the longitudinal direction, that extend through said blind holes of said blind units in an up-down direction, and that are operable to raise or lower said blind units; and
a plurality of clamping members, each of said clamping members including a plug block that is mounted in one of said blind holes of said blind units and that defines a through hole through which a corresponding one of said pull cords passes in the up-down direction, and at least one clamping slot that communicates with said through hole, that extends along a transverse direction perpendicular to the longitudinal direction and that is configured for clamping said corresponding one of said pull cords to limit movement of said corresponding one of said pull cords when said corresponding one of said pull cords is moved along the transverse direction, said at least one clamping slot having a communicating end that is proximate to and that communicates with said through hole, and a clamping end that is distal from said through hole and that is closed.
